(19) United States
(12) Patent Application Publication
(10) Pub. No.: US 2002/0117069 A1
(43) Pub. Date: Aug. 29, 2002

(54) Method and device for toning detection in a printing press

(76) Inventor: Birger Hansson, Akarp (SE)

Correspondence Address: ST. ONGE STEWARD JOHNSTON & REENS, LLC, 986 BEDFORD STREET, STAMFORD, CT, 06905-5619, US

(21) Appl. No.: 10/050,070

(22) Filed: Oct. 23, 2001

(30) Foreign Application Priority Data
Oct. 23, 2000 (SE) 0003840-6

(51) Int. Cl. B41F 1/54; B41L 5/12

(52) U.S. Cl. 101/484

(57) ABSTRACT

A toning in the form of a circumferential printing ink band (7) on printing plates on a rotating plate cylinder (1) shall be detected during operation. The reflectivity of the surface of the printing plates is axially scanned by means of a sensor (4), and a reflectivity deviating from a predetermined value in the area in question is taken as an indication of a toning.

### TECHNICAL FIELD

The present invention relates to a method and device in a printing press for detecting during operation a toning in the form of a circumferential printing ink band on printing plates on a plate cylinder.

### BACKGROUND OF THE INVENTION

As is well known in the printing art, printing ink is supplied to printing plates on a rotating plate cylinder in a printing press in a pattern corresponding to the desired print pattern, whereas the remaining areas of the printing plates are covered with a very thin layer of so called fountain solution. The printing ink is normally supplied by means of ink rollers, whereas the fountain solution may be supplied, possibly via rollers, by means of a number of spray nozzles arranged side by side in a spray bar.

If the spraying function of a spray nozzle is impaired during printing, for example due to clogging, too little fountain solution is supplied to the relevant portion in the form of a band on the printing plates, which accordingly become dry in this band. Instead, printing ink will gather in this band and create an undesired toning or scumming on the printed paper web.

A visual inspection by the printer will reveal such an undesired condition, so that an appropriate action can be taken. However, it is better to provide an automatic detection, so that the condition is revealed immediately and that the printer can concentrate on more important matters during printing.

The main object of the invention is accordingly to provide such an automatic detection of a toning condition.

### THE INVENTION

This object may according to the invention be attained in that the reflectivity of the surface of the rotating printing plates is axially scanned and that a reflectivity deviating from a predetermined value in the area in question is taken as an indication of a toning.

The reflectivity is preferably measured by means of light, for example IR light or laser light.

The predetermined values may be based on the data contents of the plates, and the data contents may be gathered by scanning the plates or by the rip, i e screen information about where ink is to be provided or not.

Another possiblity is that the predetermined values are set values approved by the printer.

As the margin adjacent to a gap for attaching a printing plate to the plate cylinder shall normally be free from printing, the reflectivity only in this region may be detected.

A device for caarying out the method defined above may according to the invention be characterized in that a sensor for emitting signals indicative for the reflectivity of the surface of the rotating printing plates is movably arranged on a rod in the axial direction of the plate cylinder.

The signals from the sensor are transmitted to a control unit, where they are processed.

### THE DRAWING

The invention will be described in further detail below under reference to the accompanying drawing, in which

FIG. 1 is a schematic top view of a plate cylinder with a detection device according to the invention and

FIG. 2 is a schematic cross-sectional view through the plate cylinder.

### DETAILED DESCRIPTION OF A PREFERRED EMBODIMENT

As is well known in the printing art, a plate cylinder 1 is rotatably mounted in a frame 2 of a printing press. The rotational speed of the plate cylinder 1 during printing may vary considerably but is normally not higher than 35 000 rph. The plate cylinder 1 is provided with printing plates for the printing of a paper web; these printing plates are not specifically shown but are normally attached to the cylinder 1 at axial gaps 3 provided therein. In the present case the cylinder 1 has two gaps 3 for the mounting of two half-cylindrical printing plates.

A sensor 4 is axially movably arranged on a rod 5 attached in the printing press frame 2. The axial speed of the sensor 4 during operation is dependent on different parameters, such as the rotation speed of the plate cylinder, the sampling conditions, etc. The sensor 4 is connected to a control unit 6, which may be a separate unit or be part of a Press Control System (PCS).

The sensor 4 is designed to emit signals indicative of the reflectivity of the printing plates. It may work by means of emitted light, for example IR light or laser light, which is reflected back to the sensor and detected. The signal emitted from the sensor 4 is supplied to the control unit 6 for processing and possible action.

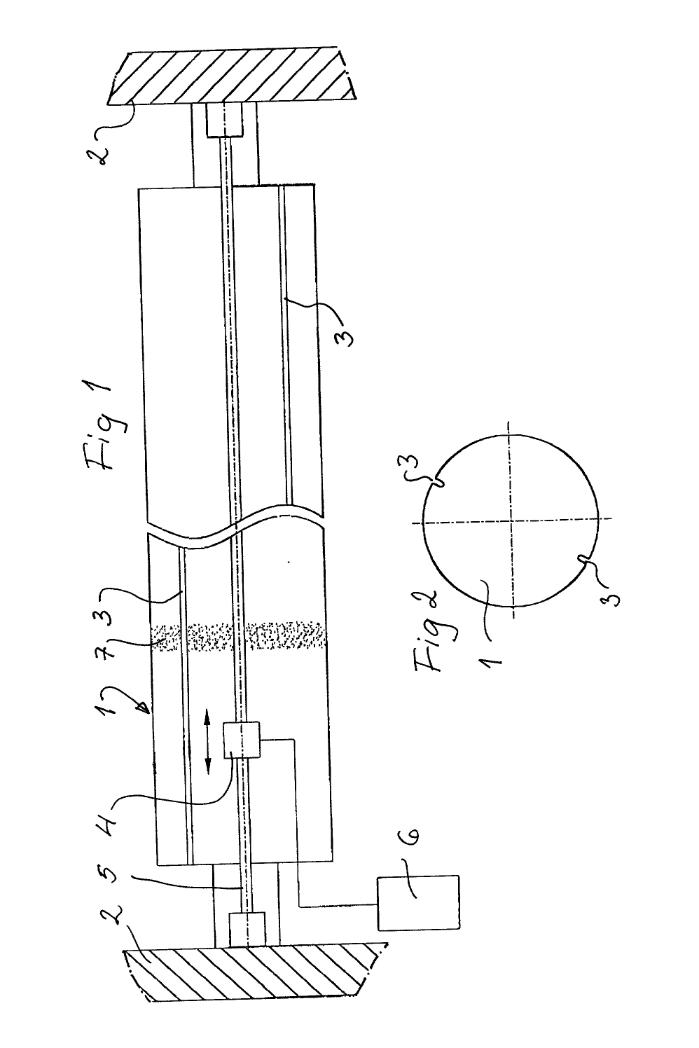

The purpose of the sensor 4 is to detect unwanted tonings on the printing plates during printing when printing ink is supplied to such areas of the printing plates that shall print on the paper web and fountain solution is supplied to other areas of the printing plates. Such a toning appears as a circumferential print ink band 7 around the plate cylinder 1, as appears in FIG. 1. Print ink bands 7 may be formed when a fountain solution nozzle is clogged, so that a dry band is formed, where printing ink adheres.

The toning can be detected as:

a) a deviation in relation to advance information, which may be in the form of:

aa) digital values of the data contents of the plate, which may be gathered by scanning the plate, by screen information about where ink is to be provided or not (“rip”) etc. In such a way it is possible to assess where there is a printing area (text, picture . . . ) or not on the plate, or in other words whether there is a free area or not.

ab) set values approved by the printer (who should be experienced).

b) a toning in the margin.

Coordinates of the margin can be found by using the position of the gap 3. The margin (along the gap) shall normally be free from ink, which means that any ink found by the sensor 4 indicates a toning. (At instances, however, certain text material—so called grey bars—may appear in the margin.)

Deviating values, which are reflected from the gap 3 and thus do not indicate a toning, may be ignored in different ways:

The gap 3 is detected by a special sensor. When this sensor detects the presence of the groove, values from the sensor 4 are ignored.

The position of the gap 3 is indicated by data from the Press Control System (PCS).

The indications from the gap 3 are totally different from “ordinary” indications from the sensor 4 and are repeated during each revolution, which means that they are ignored.

If in certain cases the gap 3 is lacking, a reference may be attained from the PCS, for example via a trigger pulse, which indicates the position of the margin, or through repetitive values at each cylinder revolution.

The action taken by the control unit 6 at the detection of a toning is normally that the printing press is stopped, so that the reason for the toning can be removed.

1. A method in a printing press for detecting during operation a toning in the form of a circumferential printing ink band (7) on printing plates on a rotating plate cylinder (1), characterized in that the reflectivity of the surface of the rotating printing plates is axially scanned and that a reflectivity deviating from a predetermined value in the area in question is taken as an indication of a toning.

2. A method according to claim 1, characterized in that the reflectivity is measured by means of light, for example IR light or laser light.

3. A method according to claim 1, characterized in that the predetermined values are based on the data contents of the plates.

4. A method according to claim 3, characterized in that the data contents are gathered by scanning the plates.

5. A method according to claim 3, characterized in that the data contents are gathered by the rip, i e screen information about where ink is to be provided or not.

6. A method according to claim 1, characterized in that the predetermined values are set values approved by the printer.

7. A method according to claim 1, characterized in that only the reflectivity in a margin adjacent to a gap (3) for attaching a printing plate to the plate cylinder (1) is detected.

8. A device in a printing press for detecting during operation a toning in the form of a circumferential printing ink band (7) on printing plates on a rotating plate cylinder (1), characterized in that a sensor (4) for emitting signals indicative for the reflectivity of the surface of the rotating printing plates is movably arranged on a rod (5) in the axial direction of the plate cylinder (1).

9. A device according to claim 8, characterized in that the signals from the sensor (4) are transmitted to a control unit (6).
